(19) United States
(12) Patent Application Publication
(10) Pub. No.: US 2026/0370525 A1
(43) Pub. Date: Nov. 19, 2026

(54) INTEGRATED FOUR-DIMENSIONAL SENSING AND DATA COMMUNICATION SYSTEM BASED ON LINEAR INTERFERENCE TECHNIQUE

(71) Applicants: HUAWEI TECHNOLOGIES CANADA CO., LTD., Kanata (CA); la Corporation de l'École Polytechnique de Montréal, Montréal (CA)

(72) Inventors: Seyed Ali KEIVAAN, Montréal (CA); Pascal BURASA, Montreal (CA); Ke WU, Montreal (CA)

(73) Assignees: HUAWEI TECHNOLOGIES CANADA CO., LTD., Kanata (CA); la Corporation de l'École Polytechnique de Montréal, Montréal (CA)

(21) Appl. No.: 19/206,512

(22) Filed: May 13, 2025

(51) Int. Cl. H04L 27/152; H04B 17/309

(52) U.S. Cl. CPC H04L 27/152; H04B 17/346

(57) ABSTRACT

Methods, apparatus, and systems are provided for sensing and communicating by wireless signals, especially for driver assistance and autonomous driving technologies. To enable detection of objects in four dimensions and subsequent communication, such as from a vehicle, implementations of the present disclosure utilize reconfigurable transceiver matrices (TMs). The reconfigurable TMs include a plurality of transceivers that can be arranged as an array and adaptively configured for sensing, transmitting signals, and receiving signals. An object's range, speed, elevation, and orientational azimuth can be detected using combinations of transceivers and by considering the polarization and Doppler shift of wireless signals. Further combinations of transceivers can be used to transmit and receive wireless signals such as modulated signals including quadrature and in-phase components.

### CROSS-REFERENCE TO RELATED APPLICATIONS

This is the first application filed for the present invention.

### FIELD OF THE INVENTION

The present application pertains to sensing technologies and in particular to methods, apparatus, and systems for radar sensing and communication.

### BACKGROUND

Sensing systems have become critical components in advanced driver assistance systems (ADASs) and autonomous driving technologies. Radar sensing can be used to enhance road safety, situational awareness, and the driving experience. Millimeter-wave (mmW) radar sensors, in particular, have gained prominence over other sensing technologies, such as camera-based or LiDAR technologies, because of these sensors' compact form factor, cost-effectiveness, resilience to adverse weather, precision in measuring speed, and long-range detection capabilities. Despite increasing deployment, current mmW sensing technologies are limited to detecting the range, azimuthal angle, and speed of objects in view, and are unable to precisely resolve the elevation of objects. Thus, they fail to fully characterize the spatial positions of objects and provide four-dimensional sensing.

Multiple-input multiple-output (MIMO) antenna technology has been investigated as one approach to enhancing elevation resolution in mmW radar sensing. In sensing systems employing MIMO technology, a fast Fourier transform (FFT) can first be applied to the received signal to generate a map that indicates the distances to objects in view of the sensors. A Doppler FFT can then used to generate a two-dimensional map that indicates both the distance of the objects and their speed, according to frequency shifts in the received signal. And lastly, an angle FFT can be applied to determine the orientational directions of the objects. Although MIMO technology has shown capability in detecting elevation, its implementation is complicated and impractical. To process the large volumes of data that MIMO systems inherently produce, complex and resource-intensive signal processing algorithms are needed. Such algorithms consequently limit the time, cost, and power efficiency of the sensing systems and make them unfeasible.

Therefore, there is a need for a method and apparatus for four-dimensional mmW radar sensing that obviates or mitigates one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

An object of implementations of the present disclosure is to provide methods, systems and apparatus for four-dimensional sensing and communication.

A first aspect of the present disclosure is to provide a method comprising: detecting, by a first set of cell elements among a plurality of cell elements of a reconfigurable transceiver matrix (TM), a target entity and, for the target entity, an elevation and an azimuth relative to the reconfigurable TM, with each cell element of the plurality of cell elements including a respective antenna coupled to a respective local oscillator (LO) phase locked to a same reference signal, and with each antenna configured to transmit and receive wireless signals; receiving, by a second set of cell elements among the plurality of cell elements of the reconfigurable TM, a first set of communication wireless signals from the target entity, with the first set of communication wireless signals defining a first data message; and transmitting, by a third set of cell elements among the plurality of cell elements of the reconfigurable TM, a second set of communication wireless signals to the target entity in accordance with the elevation and the azimuth detected for the target entity, with the second set of communication wireless signals defining a second data message, and with at least one cell element of the third set of cell elements being phase locked to the same reference signal with a 90 degree shift relative to at least one other cell element of the third set of cell elements.

In some implementations of the first aspect, the method may further comprise adding at least one cell element among the plurality of cell elements of the reconfigurable TM to the second set of cell elements to improve a value of a reception metric. In some of these implementations, the receiver metric may be a signal-to-noise ratio. In some implementations, each cell element among the plurality of cell elements of the reconfigurable TM may be either in an active state or an inactive state, each cell element of the second set of cell elements may be in the active state, and the at least one cell element may be added to the second set of cell elements by switching the at least one cell element from the inactive state to the active state.

In some implementations of the first aspect, the method may further comprise adding at least one cell element among the plurality of cell elements of the reconfigurable TM to the third set of cell elements to improve a value of a transmission metric. In some of these implementations, the transmission metric may be a signal gain. In some other implementations, each cell element among the plurality of cell elements of the reconfigurable TM may be either in an active state or an inactive state, each cell element of the third set of cell elements may be in the active state, and the at least one cell element may be added to the third set of cell elements by switching the at least one cell element from the inactive state to the active state.

In some implementations of the first aspect, the method may further comprise removing at least one cell element from the first set of cell elements, the second set of cell elements, or the third set of cell elements to improve a value of a power usage metric. In some of these implementations, each cell element among the plurality of cell elements of the reconfigurable TM is either in an active state or an inactive state, and the at least one cell element may be removed from the first set of cell elements, the second set of cell elements, or the third set of cell elements by switching the at least one cell element from the active state to the inactive state.

In some implementations of the first aspect, the second set of communication wireless signals may be transmitted to the target entity by the third set of cell elements of the reconfigurable TM when the first set of communication wireless signals is received from the target entity by the second set of cell elements of the reconfigurable TM.

In some implementations of the first aspect, each communication wireless signal of the second set of communication wireless signals may be a quadrature-amplitude modulation signal including a respective in-phase component and a respective quadrature component. In these implementations, each in-phase component may be transmitted by the at least one cell element of the third set of cell elements, and each quadrature component may be transmitted by the at least one other cell element of the third set of cell elements.

In some implementations of the first aspect, each communication wireless signal of the first set of communication wireless signals may be a quadrature-amplitude modulation signal including a respective in-phase component and a respective quadrature component, and at least one cell element of the second set of cell elements may be phase locked to the same reference signal with a 90 degree shift relative to at least one other cell element of the second set of cell elements. In these implementations, the method may further comprise detecting, when the first set of communication wireless signals is received by the second set of cell elements: each in-phase component of the first set of communication wireless signals by the at least one cell element of the second set of cell elements, and each quadrature component of the first set of communication wireless signals by the at least one other cell element of the second set of cell elements. In some of these implementations, the method may further comprise demodulating each in-phase component and each quadrature component to obtain the first data message.

In some implementations of the first aspect, each communication wireless signal of the first set of communication wireless signals may be a quadrature-amplitude modulation signal including a respective in-phase component and a respective quadrature component, each cell element of a first subset of cell elements among the second set of cell elements may include a respective power combiner, and each cell element of a second subset of cell elements among the second set of cell elements may include a respective hybrid coupler. In these implementations, the method may further comprise detecting, when the first set of communication wireless signals is received by the second set of cell elements: each quadrature component of the first set of communication wireless signals by the first subset of cell elements among the second set of cell elements, and each in-phase component of the first set of communication wireless signals by the second subset of cell elements among the second set of cell elements.

In some implementations of the first aspect, the method may further comprise detecting, by the first set of cell elements of the reconfigurable TM, a distance and a speed for the target entity and relative to the reconfigurable TM.

In some implementations of the first aspect, detecting, by the first set of cell elements of the reconfigurable TM, the target entity and, for the target entity, the elevation and the azimuth relative to the reconfigurable TM may include: transmitting, by the first set of cell elements of the reconfigurable TM, a set of sensing wireless signals; and receiving, by the first set of cell elements of the reconfigurable TM, at least a subset of the set of sensing wireless signals reflected by the target entity. In some of these implementations, the set of sensing wireless signals may have associated thereto a frequency modulation. In these implementations, detecting, by the first set of cell elements of the reconfigurable TM, the target entity and, for the target entity, the elevation and the azimuth relative to the reconfigurable TM may further include identifying, by the first set of cell elements of the reconfigurable TM, a plurality of beat frequencies in the subset of the set of sensing wireless signals depending from the frequency modulation.

In some implementations of the first aspect, each cell element of the plurality of cell elements of the reconfigurable TM may be a first polarization cell element or a second polarization cell element, with the respective antenna of each first polarization cell element having associated thereto a first polarization and the respective antenna of each second polarization cell element having associated thereto a second polarization orthogonal to the first polarization. In these implementations, the plurality of cell elements of the reconfigurable TM may be arranged to alternate between the first polarization and the second polarization in two dimensions. The first set of cell elements of the reconfigurable TM may include a first subset of cell elements and a second subset of cell elements, with each of the first subset of cell elements and the second subset of cell elements including a respective plurality of pairs of cell elements, and with each pair of cell elements including a respective first polarization cell element and a respective second polarization cell element. The elevation of the target entity may be detected by the first subset of cell elements of the first set of cell elements, and the azimuth of the target entity may detected by the second subset of cell elements of the first set of cell elements. In some implementations, the respective plurality of pairs of cell elements of the first subset of cell elements of the first set of cell elements may include a respective four pairs of cell elements arranged sequentially in one dimension of the two dimensions, and the respective plurality of pairs of cell elements of the second subset of cell elements of the first set of cell elements may include a respective four pairs of cell elements arranged sequentially in an other dimension of the two dimensions. In some implementations, the respective four pairs of cell elements of the first subset of cell elements of the first set of cell elements may be partitioned into a respective first half of pairs of cell elements separated, along the one dimension of the two dimensions, from a respective second half of pairs of cell elements by at least one cell element from among the plurality of cell elements of the reconfigurable TM. The respective four pairs of cell elements of the second subset of cell elements of the first set of cell elements may be partitioned into a respective first half of pairs of cell elements separated, along the other dimension of the two dimensions, from a respective second half of pairs of cell elements by a further at least one cell element from among the plurality of cell elements of the reconfigurable TM.

A second aspect of the present disclosure is to provide an apparatus comprising a reconfigurable TM including a plurality of cell elements each including a respective antenna coupled to a respective LO phase locked to a same reference signal. Each cell element may be configured to: detect, by a first set of cell elements among the plurality of cell elements of the reconfigurable TM, a target entity and, for the target entity, an elevation and an azimuth relative to the reconfigurable TM; receive, by the respective antenna of each cell element of a second set of cell elements among the plurality of cell elements of the reconfigurable TM, a first set of communication wireless signals from the target entity, with the first set of communication wireless signals defining a first data message; and transmit, by the respective antenna of each cell element of a third set of cell elements among the plurality of cell elements of the reconfigurable TM, a second set of communication wireless signals to the target entity in accordance with the elevation and the azimuth detected for the target entity, with the second set of communication wireless signals defining a second data message, and with at least one cell element of the third set of cell elements being phase locked to the same reference signal with a 90 degree shift relative to at least one other cell element of the third set of cell elements.

Implementations of the first aspect may facilitate sensing over four dimensions and communication with detected objects. Implementations may enable adaptive sensing and communication channels that reduce power consumption and improve signal qualities.

Implementations have been described above in conjunctions with aspects of the present disclosure upon which they can be implemented. Those skilled in the art will appreciate that implementations may be implemented in conjunction with the aspect with which they are described, but may also be implemented with other implementations of that aspect. When implementations are mutually exclusive, or are otherwise incompatible with each other, it will be apparent to those skilled in the art. Some implementations may be described in relation to one aspect, but may also be applicable to other aspects, as will be apparent to those of skill in the art.

### BRIEF DESCRIPTION OF THE FIGURES

Further features and advantages of the present disclosure will become apparent from the following detailed description, taken in combination with the appended drawings, in which:

FIG. 1A shows a schematic of an example scenario in which implementations of the present disclosure may be applied.

FIG. 1B shows example plots of frequency and beat frequency for wireless signals transmitted and received by a reconfigurable transceiver matrix (TM), in accordance with implementations of the present disclosure.

FIG. 2 shows a flowchart of a method for sensing and communicating by wireless signals, in accordance with implementations of the present disclosure.

FIG. 3 shows a schematic for communication channels formed with a reconfigurable TM, in accordance with implementations of the present disclosure.

FIG. 4A shows a schematic for a local oscillator feed network layer of a reconfigurable TM, in accordance with implementations of the present disclosure.

FIG. 4B shows a schematic for a transceiver layer of a reconfigurable TM, in accordance with implementations of the present disclosure.

FIG. 4C shows a schematic of a cell element of a reconfigurable TM, in accordance with implementations of the present disclosure.

FIG. 4D shows a schematic of a hybrid coupler of a reconfigurable TM, in accordance with implementations of the present disclosure.

FIG. 5 shows a schematic of cell elements of a reconfigurable TM that are configured for transmitting wireless signals, in accordance with implementations of the present disclosure.

FIG. 6 shows a schematic of cell elements of a reconfigurable TM that are configured for receiving wireless signals, in accordance with implementations of the present disclosure.

FIG. 7A shows a schematic of cell elements of a reconfigurable TM that include a power combiner, in accordance with implementations of the present disclosure.

FIG. 7B shows a schematic of cell elements of a reconfigurable TM that include a hybrid coupler, in accordance with implementations of the present disclosure.

FIG. 8 shows a schematic of a reconfigurable TM for polarization detection, in accordance with implementations of the present disclosure.

FIG. 9 shows a schematic of a reconfigurable TM for detecting angle of arrival, in accordance with implementations of the present disclosure.

FIG. 10 shows a schematic of an apparatus for sensing and communicating by wireless signals according to implementations of the present disclosure.

FIG. 11 shows a schematic of an implementation of an electronic device that may implement at least part of the methods and features of the present disclosure.

It will be noted that throughout the appended drawings, like features are identified by like reference numerals.

### DETAILED DESCRIPTION

The present disclosure sets forth various implementations via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof. As used herein, the term “about” should be read as including variation from the nominal value, for example, a +/−10% variation from the nominal value. It is to be understood that such a variation is always included in a given value provided herein, whether or not it is specifically referred to. The terms in each of the following sets may be considered interchangeable throughout the disclosure: cell elements, unit cells, and cells; and distance and range.

Implementations of the present disclosure are generally directed towards providing four dimensional (4D) sensing integrated with communication, especially for automotive sensing, such as for ADAS and autonomous driving, and for vehicle-to-vehicle (V2V) or vehicle-to-infrastructure (V2X) communication. In implementations, 4D sensing may encompass simultaneously measuring an azimuth, elevation, range, and speed for objects in view, towards which communications may be directed. Communications may include information obtained through sensing. Implementations may be based on reconfigurable transceiver matrix (TM) technology. A reconfigurable TM may comprise an array of transceivers (also referred to as ‘cell elements’, ‘cells’ or ‘unit cells’), each configured to transmit and receive wireless signals. Communication channels associated with the reconfigurable TM may not be fixed but rather dynamically allocated to transceivers. The transceivers can be combined as sets of transceivers through which virtual channels may be established. Allocations may adapt in real time to changing conditions and the properties of received signals, such as their angle of arrival (AoA), frequency, and polarization. For example, transceivers may be activated to improve the quality of communication signals or to sense and communicate with multiple targets, and may be deactivated to conserve power. In implementations, the wireless signals used for communication and/or sensing may be radar signals, which may be mmW electromagnetic signals having, for example, a frequency comprised between 30 and 300 GHz and/or a wavelength comprised between 1 and 10 mm. The wireless signals may further be fifth generation (5G) or sixth generation (6G) cellular signals. Transceivers may use interferometric technology for sensing.

Use of reconfigurable TM technology in implementations may facilitate improvements in scalability and adaptability in sensing and communication by increasing the number of sensing and communication channels available. It may further enable improvements in signal-to-noise, power efficiency, and processing complexity.

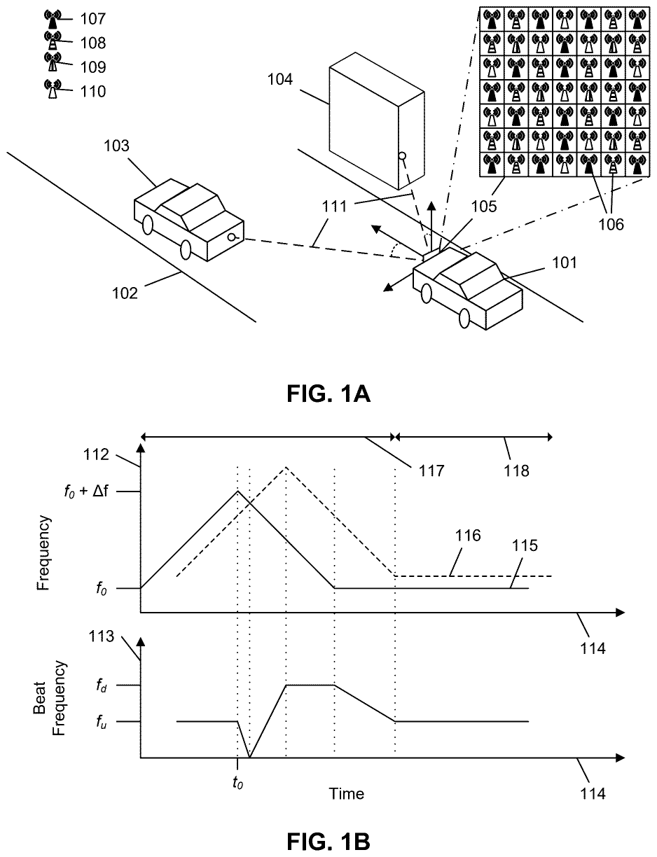

FIG. 1A shows an example of a scenario in which an implementation of the present disclosure may be applied. In the scenario, a first car 101 is driving on one side of a road 102 towards a second car 103, which is approaching on an opposite side of the road 102. A structure 104, such as a building or natural feature, is present along the road 102 in front of the first car 101. The first car 101 includes a reconfigurable TM 105 comprising a plurality of transceivers 106. The reconfigurable TM 105 may be positioned on a front portion of the first car 101 and may be oriented towards the direction of travel. In this example, the transceivers 106 are arranged as a two-dimensional array. Each transceiver 106 may be configured to transmit and receive wireless signals. In the example, among the plurality of transceivers 106, a first set 107 is presently configured for sensing (indicated by solid fill in FIG. 1A), a second set 108 is presently configured for receiving communication wireless signals (indicated by horizontal stripes), a third set 109 is presently configured for transmitting communication wireless signals (indicated by vertical stripes), and a fourth set 110 (i.e., the remainder) is presently inactive (indicated by no fill). Each transceiver 106 of the reconfigurable TM 105 may be reconfigured to belong to each of the first set 107, the second set 108, the third set 109, or the fourth set 110. Each transceiver 106 may be either in an active state (and thus belong to the first set 107, the second set 108, or the third set 109) or in an inactive state (and thus belong to the fourth set 110). Reconfiguring each transceiver 106 may include switching the respective transceiver 106 between the active and inactive states. The reconfigurable TM 105 may transmit wireless signals 111 towards each of the second car 103 and the structure 104 to detect them, as target entities, and once detected, communicate with them. Detecting the second car 103 and the structure 104 may include sensing a distance (or range), speed, azimuth, and elevation relative to the reconfigurable TM 105. Azimuth may be an angular measure of the direction towards a target entity in a plane parallel with the ground. Elevation may be an angular measure of the direction towards the target entity upwards from the ground. Each of the second car 103 and the structure 104 may similarly be equipped with a respective reconfigurable TM 105 to sense and communicate with the first car 101.

FIG. 1B shows example plots of frequency 112 and beat frequency 113 over time 114 for wireless signals transmitted from a reconfigurable TM 105 in accordance with implementations of the present disclosure. The wireless signals may, for example, be those transmitted by the reconfigurable TM 105 in the example described in relation to FIG. 1A. A series of two signal cycles may be transmitted 115 from the reconfigurable TM 105, and at least a portion of the signals transmitted may be returned and received 116 by the reconfigurable TM 105 after a time delay. The received signals 116 may be transmitted signals that have reflected or scattered from a target entity, such as the second car 102 or the structure 104, or any other object in view of the reconfigurable TM 105. The received signals 116 may experience a Doppler shift resulting from relative movement of the target entity with respect to the reconfigurable TM 105. A first signal cycle 117 of the two signal cycles may be directed towards detecting and sensing target entities using ‘sensing wireless signals’, while a second signal cycle 118 of the two signal cycles may be directed towards communicating with any detected target entities using ‘communication wireless signals’. During the first signal cycle 117, the frequency 112 of the transmitted wireless signals may be modulated. This may include increasing the frequency from an initial frequency f₀ by an amount Δ_{f} and subsequently, at time t₀, decreasing the frequency back to the initial frequency. The frequency modulation may produce a first beat frequency or up-beat frequency fᵤ corresponding to when both the transmitted 115 and received 116 signals are increasing in frequency. The frequency modulation may further produce a second beat frequency or a down-beat frequency f_{d} corresponding to when both the transmitted 115 and received 116 signals are decreasing in frequency. During the second signal cycle 118, the frequency 112 of the transmitted wireless signals may remain constant at the initial frequency. The first signal cycle 117 and the second signal cycle 118 may be repeated one or more times.

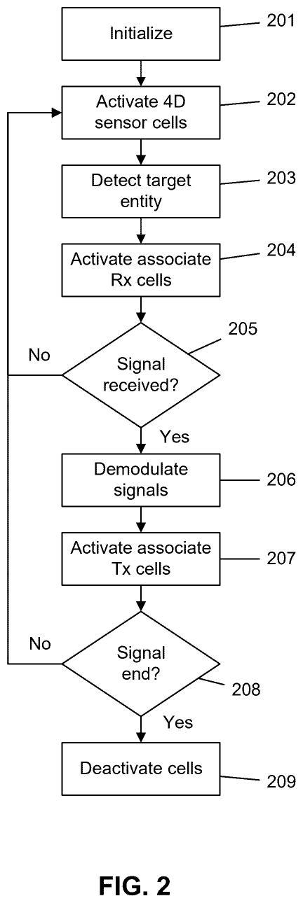

FIG. 2 shows a flowchart of a method for sensing and communication in accordance with implementations of the present disclosure. The method may be implemented using a reconfigurable TM 105. At action 201, the reconfigurable TM 105 may be initialized to detect one or more target entities in view of the reconfigurable TM 105. At action 202, a first set 107 of transceivers among the plurality of transceivers 106 of the reconfigurable TM 105 may be activated and configured for sensing (i.e., configured as ‘4D sensor cells’). At action 203, a target entity may be detected by the first set of transceivers. This may include transmitting, by the first 107 set of transceivers, a set of sensing wireless signals and receiving, by the first set 107 of transceivers, at least a subset of the set of sensing wireless signals reflected (or scattered) by the target entity. Action 203 may further include detecting, for the target entity, an elevation, an azimuth, a distance, and/or a speed using the sensing wireless signals.

At action 204, a second set 108 of transceivers among the plurality of transceivers 106 of the reconfigurable TM 105 may be activated and configured for receiving communication wireless signals (i.e., configured as ‘Rx cells’). Action 204 may further include receiving a first set of communication wireless signals, by the second set 108 of transceivers, from the target entity. The first set of communication wireless signals may define a first data message and may be modulated according to a quadrature amplitude modulation (QAM) scheme such that each communication wireless signal includes a respective quadrature component and a respective in-phase component. At action 205, the reception of the first set of communication wireless signals may be evaluated. If the first set of communication wireless signals is not received or the quality of the received signals is insufficient, additional transceivers 106 of the reconfigurable TM 105 may be activated as Rx cells and/or 4D sensor cells by repeating actions 202 to 204. This may include adding at least one transceiver 106 from among the plurality of transceivers 106 of the reconfigurable TM 105 to the second set 108 of transceivers. It may further include switching the at least one transceiver 106 from being in the inactive state to the active state. Sufficient quality of received wireless signals may be determined according to a value of a reception metric, such as a signal-to-noise ratio for the received wireless signals.

When the first set of communication wireless signals is received, those communication wireless signals may be demodulated to obtain the data message, at action 206. At action 207, a third set 109 of transceivers among the plurality of transceivers 106 of the reconfigurable TM 105 may be activated and configured for transmitting communication wireless signals (i.e., configured as ‘Tx cells’). Action 207 may further include transmitting a second set of communication wireless signals, by the third set 109 of transceivers, to the target entity. The second set of communication wireless signals may define a second data message and may be modulated according to the QAM scheme such that each communication wireless signal includes a respective quadrature component and a respective in-phase component. The second set of communication wireless signals may be transmitted in accordance with the detected azimuth, elevation, distance, and/or speed for the target entity. Sufficient quality for the transmission of the second set of communication wireless signals may be evaluated according to a value of a transmission metric, such as a signal gain. To improve the transmission metric, additional transceivers 106 of the reconfigurable TM 105 may be activated as Tx cells. This may include adding at least one transceiver 106 from among the plurality of transceivers 106 of the reconfigurable TM 105 to the third set 109 of transceivers. It may further include switching the at least one transceiver 106 from being in the inactive state to the active state.

At action 208, the reception of communication wireless signals from the target entity may be evaluated to determine whether communication with the target entity has finished. If the first set of communication wireless signals are still being received, additional transceivers 106 of the reconfigurable TM 105 may be activated as Tx cells, Rx cells and/or 4D sensor cells by repeating actions 202 to 207. These actions may be repeated, for example, to improve the value of the reception metric and/or the value of the transmission metric. When the reception of communication wireless signals from the target entity has finished, one or more transceivers among the first set 107 of transceivers, the second set 108 of transceivers, and/or the third set 109 of transceivers may be deactivated, at action 209, by switching the one or more transceivers from the active state to the inactive state. This may include removing the one or more transceivers from the first set 107 of transceivers, the second set 108 of transceivers, and/or the third set 109 of transceivers, and adding the one or more transceivers to the fourth set 110 of transceivers. Deactivation of the one or more transceivers may be done to conserve power. In other words, deactivation may be done to improve a value of a power usage metric.

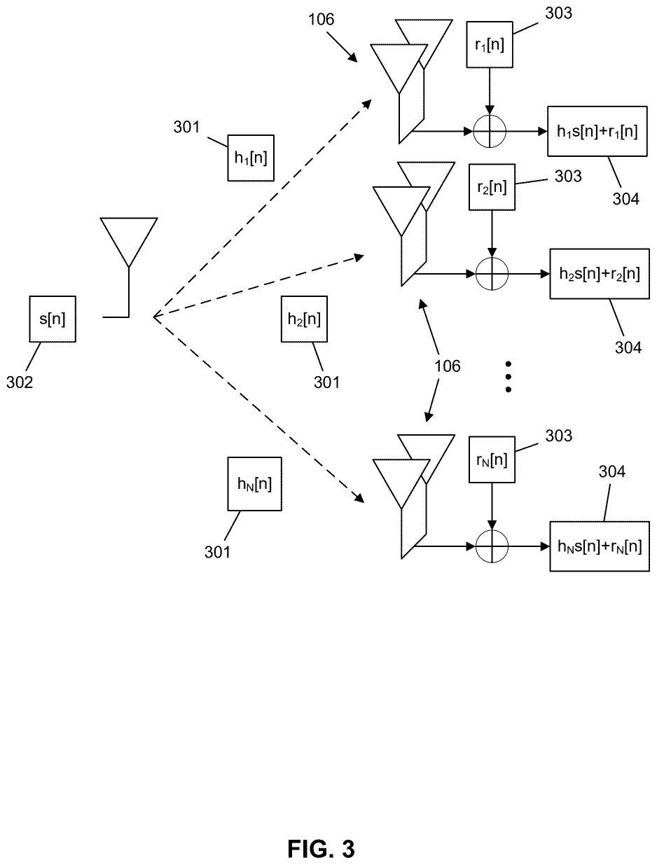

FIG. 3 shows a schematic for N communication channels 301 hᵢ[n] formed between a transmission source 302 and a corresponding N groups of transceivers 106 of a reconfigurable TM 105, in accordance with implementations of the present disclosure, where N is a natural number, n indexes symbols transmitted by the communication channels, and i indexes the communication channels. The N communication channels 301 may constitute a virtual TM channel. The transmission source 302 may, for example, be a target entity and may transmit a source signal s[n]∈{+1, −1}, which may have, for example, been modulated such as with binary phase shift keying (BPSK) modulation. Each transceiver 106 of the N groups of transceivers 106 may be configured for receiving communication wireless signals and so may belong to a third set 109 of transceivers of the reconfigurable TM 105. Each group of transceivers 106 of the N groups of transceivers 106 may include two or more transceivers 106. The groups of transceivers 106 may have been allocated respective communication channels 301 dynamically or may have formed in a floating manner. The signals received by each group of transceivers 106 may be subject to respective additive white Gaussian noise (AWGN) 303 rᵢ[n]~CN(0, σ²), where σ is the variance. Fading in the communication channels 301 and the AWGN 303 may result in received signals 304 hᵢs[n]+rᵢ[n]. If the channels are faded independently, the probability Pᵣ that the virtual TM channel is in a deep fade may approximately be described by:

$${P}_{r} ( C ( {M}^{2} , 2 ) ( {\vert {h}_{1} \vert}^{2} S N R < 1 ) \& … \& C ( {M}^{2} , 2 ) ( {\vert {h}_{1} \vert}^{2} S N R < 1 ) ) = {( {P}_{r} ( {\vert {h}_{1} \vert}^{2} S N R < 1 ) )}^{N} \approx \frac{1}{C ( {M}^{2} , 2 ) \cdot S N {R}^{N}} \qquad ( 1 )$$

where C is a combination formula, M is the number of elements in the matrix (i.e., the matrix is M×M), and SNR is the signal-to-noise ratio. The formation of virtual TM channels with a reconfigurable TM 105 in this manner may facilitate improvements in the bit error rate for the transmitted communication wireless signals, especially in comparison to transmissions by a single-input single-output (SISO) system. These improvements may heighten with increasing numbers of transceivers 106 allocated to each group of transceivers 106.

In implementations of the present disclosure, a local oscillator (LO) signal may be evenly distributed across the plurality of transceivers 106 of the reconfigurable TM 105. Even distribution may be achieved by use of a LO feed network wherein each transceiver 106 includes a respective LO, such as a respective field-effect transistor (FET) oscillator, which may be localized to the respective transceiver 106 and may be synchronized, or phase locked, to a same reference LO signal. The reconfigurable TM 105 may be partitioned such that a first portion, such as a half, of the plurality of transceivers are phase-locked with about a 90 degree shift relative to a second portion, such as the other half, of the plurality of transceivers 106. This partitioning may enable transmissions of QAM communication wireless signals (or more briefly, QAM signals) including quadrature and in-phase components. To transmit a QAM signal, at least one transceiver 106 of the first portion may be used to transmit the quadrature (or in-phase) component and at least one transceiver 106 of the second portion may be used to transmit the in-phase (or quadrature) component. In the far field, the quadrature and in-phase components radiated by the corresponding transceivers 106 may combine and form the QAM signal.

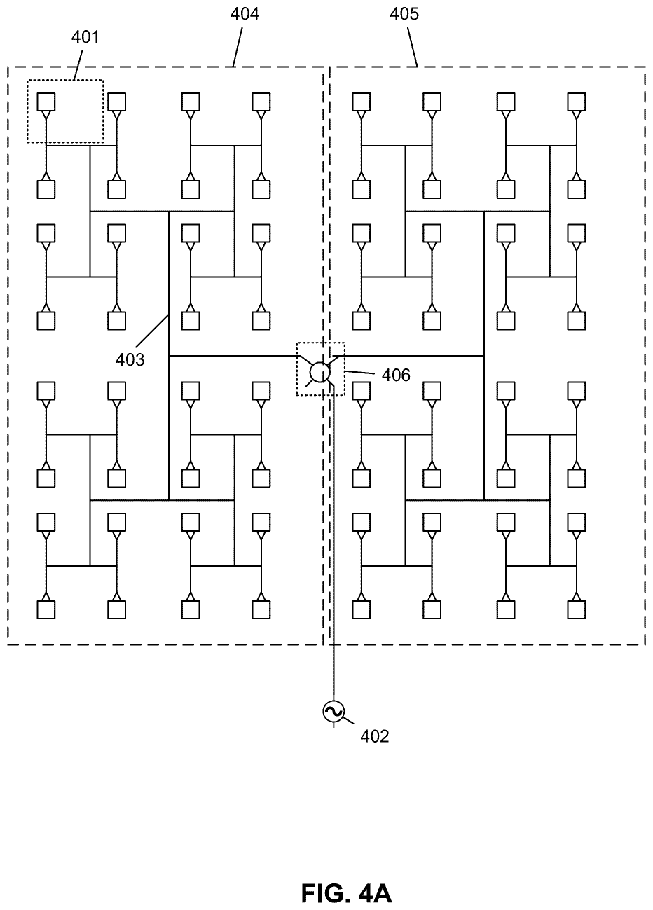

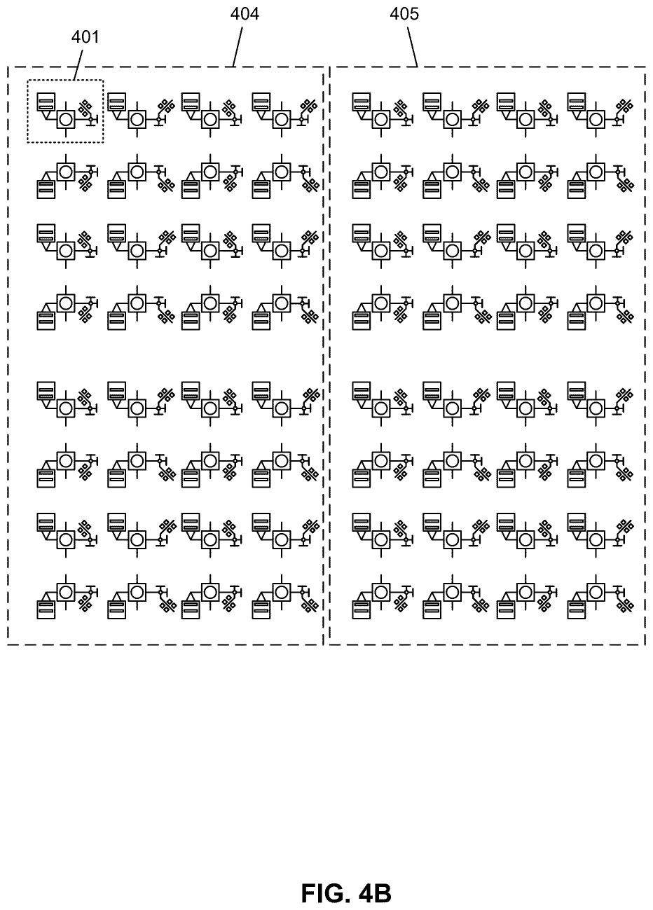

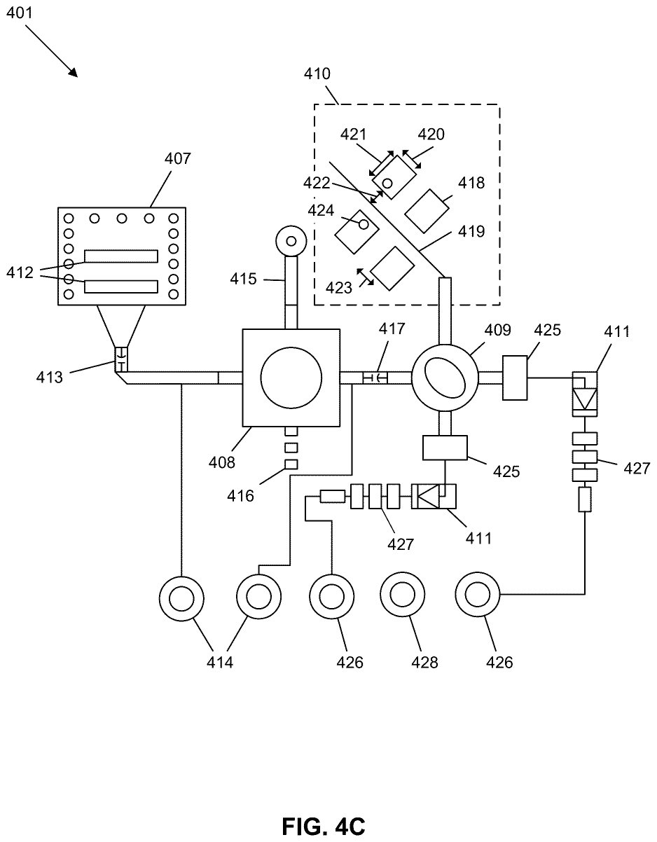

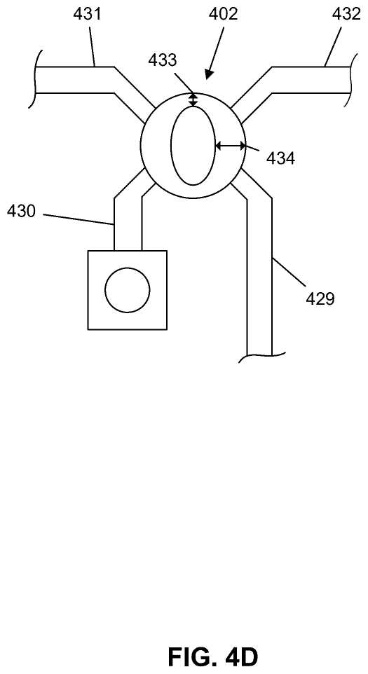

FIG. 4A shows a schematic for an example of a LO feed network layer of a reconfigurable TM 105, in accordance with an implementation of the present disclosure. The reconfigurable TM 105 may include the LO feed network layer and a transceiver layer. Each of the LO feed network layer and the transceiver layer may, for example, be constructed as a separate printed circuit on a substrate, such as a RO3010 substrate. Each of the LO feed network layer and the transceiver layer may, for example, have a thickness of about 10 mils with about 17 μm metalization. In other implementations, the reconfigurable TM 105 may be implemented as an integrated circuit chip rather than printed circuits. The reconfigurable TM 105 may further include a plurality of cell elements 401 (or ‘unit cells’ or ‘cells’), which each represent a respective transceiver of the plurality of transceivers 106. The LO feed network layer may include a connection to a reference LO 402, which may provide a low-power reference signal for synchronization. The reference signal obtained from the reference LO 402 may be distributed to each cell element 401 via microstrip lines 403 in the LO feed network layer. The microstrip lines 403 may, for example, have widths comprised between about 0.2 and 0.5 mm. The plurality of cell elements may be divided into a first portion 404 and a second portion 405. A hybrid coupler 406 may connect each of the first portion 404 of cell elements and the second portion 405 of cell elements to the reference LO 402. The hybrid coupler may introduce a phase shift, such as the 90 degree phase shift described previously, between the first portion 404 and the second portion 405.

FIG. 4B shows a schematic for an example of a transceiver layer of a reconfigurable TM 105, in accordance with an implementation of the present disclosure. The transceiver layer may correspond to the LO feed network layer described in relation to FIG. 4A. The transceiver layer may include the plurality of cell elements 401.

FIG. 4C shows a schematic for an example of a cell element 401 of a reconfigurable TM 105, in accordance with an implementation of the present disclosure. The cell element 401 may correspond to that described in relation to FIGS. 4A and 4B. The cell element 401 may include a coupling cavity 407, a FET oscillator 408, a hybrid coupler 409, an antenna 410, and one or more power detectors 411.

The coupling cavity 407 may couple the cell element 401 to the reference LO 402 and may include, for example, two coupling slots 412. The coupling cavity 407 may, for example, be a substrate-integrated waveguide (SIW) coupling cavity. The two coupling slots 412 may, for example, have lengths of about 2.3 mm, widths of about 0.3 mm, and a separation of about 1.3 mm. The thickness of the coupling cavity may, for example, be about 10 mils. The coupling cavity 407 may be connected to the FET oscillator 408 through a decoupling capacitor 413.

The FET oscillator 408 may be connected to: one or more voltage sources 414 for biasing, which may switch the cell element between being active and inactive; a power source 415 with a load, which may introduce instability to the FET oscillator 408 at a particular frequency; one or more tunable loads 416; and the hybrid coupler 409, via a further decoupling capacitor 417.

The hybrid coupler 409 may connect the FET oscillator 408, the antenna 410, and each of the power detectors 411.

The antenna 410 may be configured, for example, as a wideband microstrip antenna including an array of rectangular patches 418 having a log-periodic arrangement about a feed line 419. The rectangular patches 418 may be coupled to the feed line 419 by proximity coupling. The p^{th} rectangular patch 418 may have associated thereto a respective width 420 Wₚ, a respective length 421 Lₚ, and a respective separation 422 Gₚ from the feed line 419. A center-to-center value 423 D_{p,q} may characterize the separation between the p^{th} rectangular patch 418 and the q^{th} rectangular patch 418. For the p^{th} rectangular patch 418, the respective width 420, respective length 421, and center-to-center values 423 for neighboring rectangular patches 418 may be set according to a first scaling factor k₁ such that:

$${k}_{1} = \frac{{W}_{p}}{{W}_{p - 1}} = \frac{{L}_{p}}{{L}_{p - 1}} = \frac{{D}_{p , p + 1}}{{D}_{p - 1 , p}} \qquad ( 2 )$$

The first scaling factor may be chosen, for example, to be about 1.05. For the p^{th} rectangular patch 418, the respective separation 422 may be set according to a second scaling factor k₂ such that:

$${k}_{2} = \frac{{G}_{p}}{{G}_{p - 1}} \qquad ( 3 )$$

The second scaling factor may be chosen, for example, to be about 1.03. Each of the first scaling factor and the second scaling factor may be chosen to optimize the operational bandwidth of the antenna 410. The number of rectangular patches 418 included in the antenna 410 may be chosen to optimally balance bandwidth and scalability. The antenna 410 may further include one or more shorting pins 424, which may serve as absorbing terminals. The antenna 410 may have a ±45 degree rotation, as defined by the orientation of the feed line 419, which may determine whether the antenna 410 has a first polarization or a second polarization orthogonal to the first polarization. The antenna 410 may be configured to transmit and/or receive wireless signals, such as mmW signals.

Each power detector 411 may be connected to the hybrid coupler 409 through a respective matching circuit element 425, which may ensure out power can be detected. Each power detector 411 may, for example, be a zero-biased Schottky diode, such as a GaAs Schottky diode. Each power detector may be connected to a respective output port 426 through a respective low-pass filter 427, which may suppress high-order harmonics.

The cell element 401 may further include a ground port 428.

FIG. 4D shows a schematic of an example of a hybrid coupler 402 used in a LO feed network layer of a reconfigurable TM 105, in accordance with an implementation of the present disclosure. The hybrid coupler 402 may include a first microstrip connection 429 to the reference LO 402, a second microstrip connection 430 to a via, a third microstrip connection 431 to the first portion 404 of the plurality of cell elements, and a fourth microstrip connection 432 to the second portion 405 of the plurality of cell elements. The hybrid coupler 402 may have associated thereto a radius, which may, for example, be about 0.67 mm. The hybrid coupler 402 may further have associated thereto a first dimension 433, which may be about 0.25 mm, and a second dimension 434, which may be about 0.45 mm.

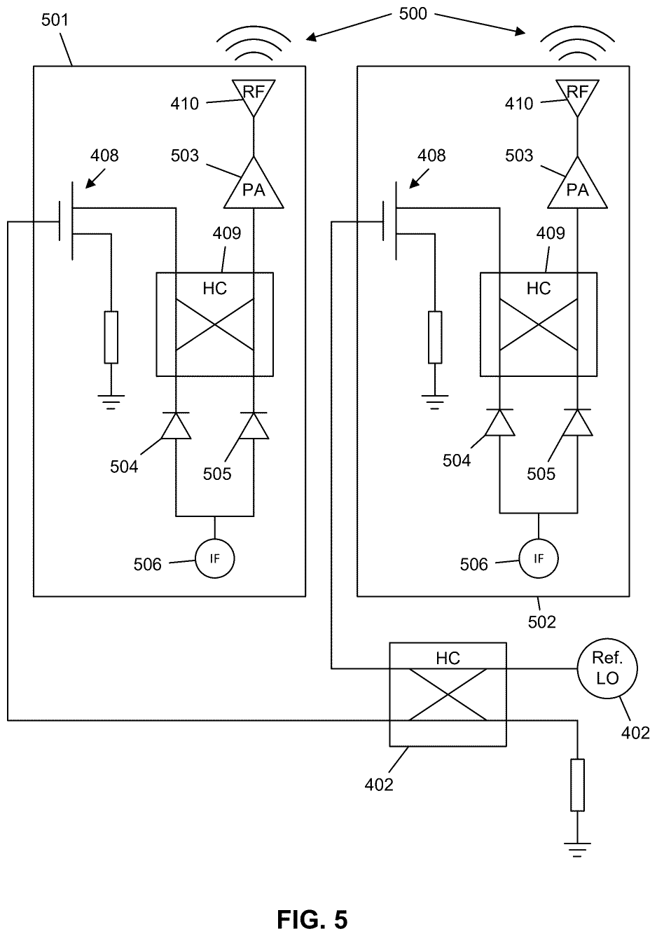

FIG. 5 shows a schematic of a first cell element 501 and a second cell element 502 configured for transmitting communication wireless signals 500, in accordance with an implementation of the present disclosure. Each of the first cell element 501 and the second cell element 502 may be configured similarly to that described in relation to FIG. 4C. In FIG. 5, each of the first cell element 501 and the second cell element 502 is shown including: a respective antenna 410, which may be configured to transmit radio-frequency (RF) or mmW wireless signals 500; a respective power amplifier (PA) 503; a respective hybrid coupler (HC) 409; a respective first power detector 504 and a respective second power detector 505, each of which may be configured similarly to the power detector 411 described previously; a respective FET oscillator 408; and a respective intermediate frequency (IF) source 506. Each of the first cell element 501 and the second cell element 502 may belong to a reconfigurable TM 105 and the respective FET oscillator 408 may be phase-locked to a same reference LO signal produced by a reference LO 402. Each of the first cell element 501 and the second cell element 502 may be connected to the reference LO 402 through a hybrid coupler 402 such that second cell element 502 is phase locked with a 90 degree shift relative to the first cell element 501. Each FET oscillator 408 may be configured to produce a respective input LO signal S_{LO}(t) for the respective cell element, which may vary with time t. The respective first power detector 504 of the first cell element 501 may detect a first reflection coefficient Γ₁ depending from one output port of the respective hybrid coupler 409, and the respective second power detector 505 of the first cell element 501 may detect a second reflection coefficient Γ₂ depending from another output port of the respective hybrid coupler 409. The respective first power detector 504 of the second cell element 502 may detect a third reflection coefficient Γ₃ depending from one output port of the respective hybrid coupler 409, and the respective second power detector 505 of the second cell element 502 may detect a fourth reflection coefficient Γ₄ depending from another output port of the respective hybrid coupler 409.

For the first cell element 501, the respective input LO signal may be represented as:

S_{LO}(t)=α_{LO}e^{jωt} (4)

where a_{LO} and ω are respectively the amplitude and frequency of the respective FET oscillator 408. The communication wireless signal 500 S_{RF}(t) generated by the respective antenna 410 may be represented as:

S_{RF}(t)=Ka_{LO}[Γ₁(t)+Γ₂(t)]e^{jωt} (5)

where K is a constant determined by the types of the respective first power detector 504 and the respective second power detector 505. The summation of reflection coefficients in Equation 5 may be assigned to represent an in-phase component I(t) of communication wireless signals 500, or more specifically QAM signals, such that:

Γ₁(t)+Γ₂(t)=α(t)cos(θ(t))=I(t) (6)

where α(t) and θ(t) are respectively the modulated amplitude and phase of baseband signals.

For the second cell element 501, which may have a 90 degree phase shift with respect to the first cell element 501, the respective input LO signal may be represented as:

S′_{LO}(t)=jα_{LO}e^{jωt} (7)

where α_{LO} and ω are respectively the amplitude and frequency of the respective FET oscillator 408. The communication wireless signal 500 S′_{RF}(t) generated by the respective antenna 410 may be represented as:

S′_{RF}(t)=jKa_{LO}[Γ₃(t)+Γ₄(t)]e^{jωt} (8)

where K is a constant determined by the types of the respective third power detector 504 and the respective fourth power detector 505. The summation of reflection coefficients in Equation 8 may be assigned to represent a quadrature component Q(t) of communication wireless signals 500, or more specifically QAM signals, such that:

Γ₃(t)+Γ₄(t)=α(t)sin(θ(t))=Q(t) (9)

where α(t) and θ(t) are respectively the modulated amplitude and phase of baseband signals.

Therefore, a summation of the signals generated by the first cell element 501 and the second cell element 502 will be radiated together as a QAM signal.

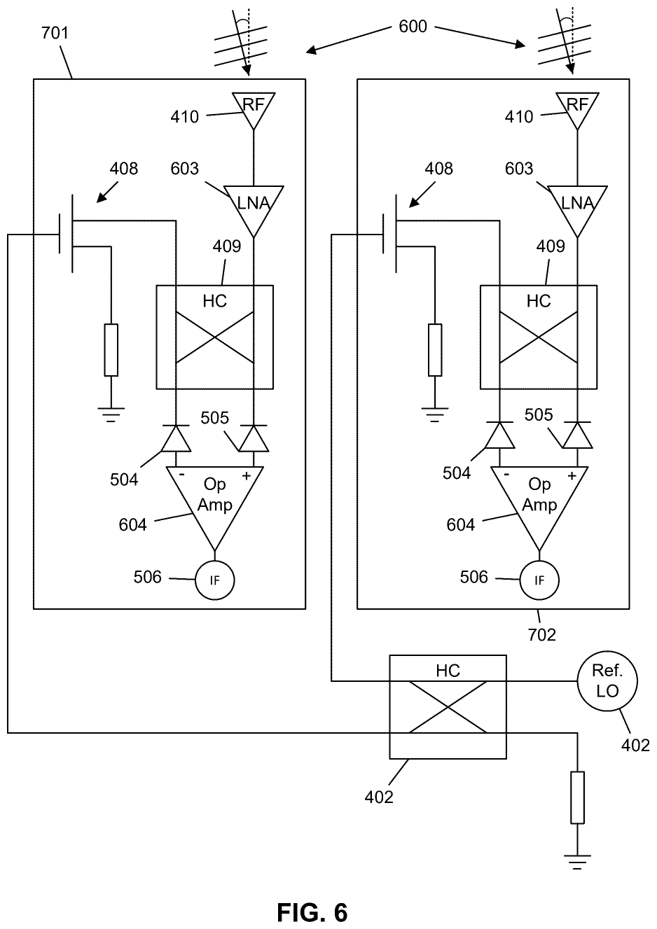

FIG. 6 shows a schematic of a first cell element 601 and a second cell element 602 configured for receiving communication wireless signals 600, in accordance with an implementation of the present disclosure. The communication wireless signals 600 may, for example, be QAM signals including a quadrature component and an in-phase component. Each of the first cell element 601 and the second cell element 602 may be configured similarly to that described in relation to FIG. 4C. In FIG. 6, each of the first cell element 601 and the second cell element 602 is shown including: a respective antenna 410, which may be configured to receive RF or mmW wireless signals; a respective low-noise amplifier (LNA) 603; a respective hybrid coupler 409; a respective first power detector 504 and a respective second power detector 505, each of which may be configured similarly to the power detector 411 described previously; a respective FET oscillator 408; a respective operational amplifier 604; and a respective IF source 506. Each of the first cell element 601 and the second cell element 602 may belong to a reconfigurable TM 105 and the respective FET oscillator 408 may be phase-locked to a same reference LO signal produced by a reference LO 402. Each of the first cell element 601 and the second cell element 602 may be connected to the reference LO 402 through a hybrid coupler 402 such that second cell element 602 is phase locked with a 90 degree shift relative to the first cell element 601. In FIG. 6, communication wireless signals 600 are received with an AoA with respect to the reconfigurable TM 105. The AoA may, for example, be an orientational angle relative to a normal of the reconfigurable TM 105 when the plurality of cell elements of the reconfigurable TM 105 are arranged as a 2D array. Each FET oscillator 408 may be configured to produce a respective input LO signal S_{LO}(t) for the respective cell element, which may vary with time t. The respective first power detector 504 of the first cell element 601 may detect a first output signal ψ₁ depending from one output port of the respective hybrid coupler 409 and may accordingly generate a first voltage V₁. The respective second power detector 505 of the first cell element 601 may detect a second output signal ψ₂ depending from another output port of the respective hybrid coupler 409 and may accordingly generate a second voltage V₂. The respective first power detector 504 of the second cell element 602 may detect a third output signal ψ₃ depending from one output port of the respective hybrid coupler 409 and may accordingly generate a third voltage V₃. The respective second power detector 505 of the second cell element 602 may detect a fourth output signal ψ₄ depending from another output port of the respective hybrid coupler 409 and may accordingly generate a fourth voltage V₄.

For the first cell element 601, the respective communication wireless signal 600 that is received and processed by the respective LNA 603 may be represented as:

S_{RF}(t)=a_{RF}α(t)e^{j(ωt+θ(t)} (10)

where a_{RF} and ω are respectively the amplitude and frequency of the carrier wave of the signal 600. With the reference LO signal injected to the respective hybrid coupler 409, as represented by Equation 4, the first and second output signals of the respective hybrid coupler 409 may be represented as:

$${ψ}_{1} ( t ) = \frac{- {a}_{LO}}{\sqrt{2}} {e}^{j ω t} [ j \frac{{a}_{RF}}{{a}_{LO}} α ( t ) {e}^{j θ ( t )} + 1 ] \qquad ( 11 )$$

$${ψ}_{2} ( t ) = \frac{- {a}_{LO}}{\sqrt{2}} {e}^{j ω t} [ \frac{{a}_{RF}}{{a}_{LO}} α ( t ) {e}^{j θ ( t )} + j ] \qquad ( 12 )$$

where α(t) and θ(t) are again respectively the modulated amplitude and phase of baseband signals. The corresponding voltages generated by the respective first power detector 504 and the respective second power detector 505 may be proportional to the received power and represented as:

Vᵢ(t)=K|ψᵢ(t)|² i=1,2 (13)

where K is again a constant determined by the types of the respective first power detector 504 and the respective second power detector 505. Accordingly, Equation 13 may be expanded for each of the first voltage and the second voltage as:

$${V}_{1} ( t ) = K \frac{{a}_{LO}^{2}}{2} [ 1 + {( \frac{{a}_{RF}}{{a}_{LO}} )}^{2} {α}^{2} ( t ) - 2 ( \frac{{a}_{RF}}{{a}_{LO}} ) α ( t ) sin ( θ ( t ) ) ] \qquad ( 14 )$$

$${V}_{2} ( t ) = K \frac{{a}_{LO}^{2}}{2} [ 1 + {( \frac{{a}_{RF}}{{a}_{LO}} )}^{2} {α}^{2} ( t ) + 2 ( \frac{{a}_{RF}}{{a}_{LO}} ) α ( t ) sin ( θ ( t ) ) ] \qquad ( 15 )$$

The respective operational amplifier 604 may be used to find a differential voltage V_{D} between the first voltage and the second voltage, which may provide a quadrature component Q(t) of the received communication wireless signal 600 and may be represented as:

V_{D}(t)=Q(t)=2Ka_{LO}a_{RF}[α(t)sin(θ(t))] (16)

The phase difference Δφ_{RF} between the communication wireless signals 600 received by each of the first cell element 601 and the second cell element 602 may be represented as:

$$Δ {ϕ}_{RF} = \frac{2 π}{λ} dcos ( AoA ) \qquad ( 17 )$$

where d is the distance between the first cell element 601 and the second cell element 602 and λ is the operational wavelength.

For the second cell element 602, the respective communication wireless signal 600 that is received and processed by the respective LNA 603 may be represented, using Equation 17, as:

S′_{RF}(t)=a_{RF}α(t)e^{j(ωt+θ(t))}e^{jΔφ}^{_{RF}} (18)

With the reference LO signal injected to the respective hybrid coupler 409, as represented by Equation 7, the third and fourth output signals of the respective hybrid coupler 409 may be represented as:

$${ψ}_{3} ( t ) = \frac{- {ja}_{LO}}{\sqrt{2}} {e}^{j ω t} [ 1 + \frac{{a}_{RF}}{{a}_{LO}} α ( t ) {e}^{j ( θ ( t ) + Δ {ϕ}_{RF} )} ] \qquad ( 19 )$$

$${ψ}_{4} ( t ) = \frac{{a}_{LO}}{\sqrt{2}} {e}^{j ω t} [ 1 - \frac{{a}_{RF}}{{a}_{LO}} α ( t ) {e}^{j ( θ ( t ) + Δ {ϕ}_{RF} )} ] \qquad ( 20 )$$

where α(t) and θ(t) are again respectively the modulated amplitude and phase of baseband signals. The corresponding voltages generated by the respective first power detector 504 and the respective second power detector 505 may be proportional to the received power and represented as:

$${V}_{3} ( t ) = K \frac{{a}_{LO}^{2}}{2} [ 1 + {( \frac{{a}_{RF}}{{a}_{LO}} )}^{2} {α}^{2} ( t ) + 2 ( \frac{{a}_{RF}}{{a}_{LO}} ) α ( t ) cos ( θ ( t ) + Δ {ϕ}_{RF} ) ] \qquad ( 21 )$$

$${V}_{4} ( t ) = K \frac{{a}_{LO}^{2}}{2} [ 1 + {( \frac{{a}_{RF}}{{a}_{LO}} )}^{2} {α}^{2} ( t ) - 2 ( \frac{{a}_{RF}}{{a}_{LO}} ) α ( t ) cos ( θ ( t ) + Δ {ϕ}_{RF} ) ] \qquad ( 22 )$$

The respective operational amplifier 604 may be used to find a differential voltage V′_{D} between the third voltage and the fourth voltage, which may be represented as:

V′_{D}(t)=2Ka_{LO}a_{RF}[α(t)cos(θ(t)+Δφ_{RF})] (23)

By selecting the first cell element 601 and the second cell element 602 from among the plurality of cell elements of the reconfigurable TM 105 such that Δφ_{RF}=2nπ, where n is a whole number, an in-phase component I(t) of the received communication wireless signal 600 may be determined and represented as:

V′_{D}(t)=I(t)=2Ka_{LO}a_{RF}[α(t)cos(θ(t))] (24)

Demodulation of the quadrature component and the in-phase component may be achieved by considering their complex vector I(t)+jQ(t).

In some implementations of the present disclosure, the need for selecting cell elements being phase locked with a 90 degree shift to demodulate the quadrature and in-phase components of received communication wireless signals 600, as described in relation to FIG. 6, may be removed by using a set of four cell elements instead of two. In these implementations, two of the four cell elements may include a respective hybrid coupler 409 while the other two cell elements may instead include a respective power combiner.

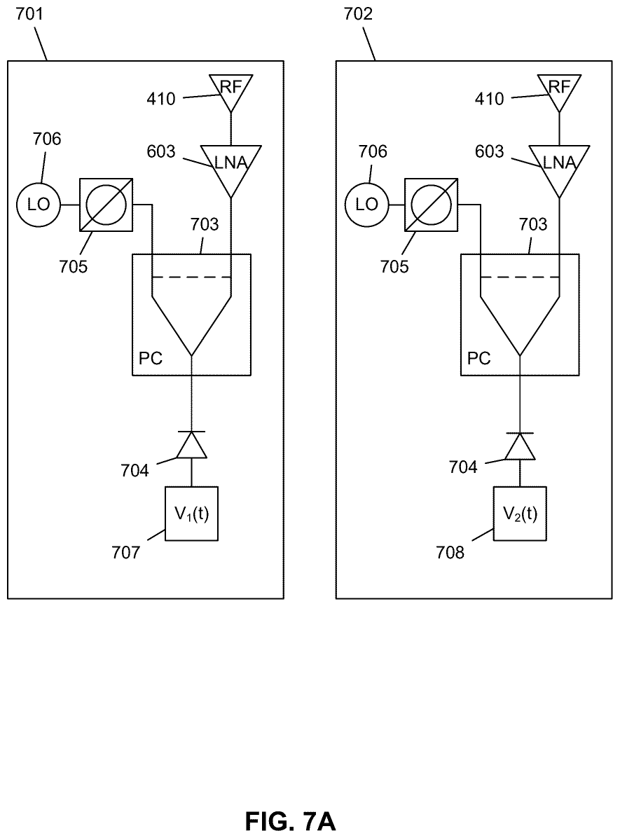

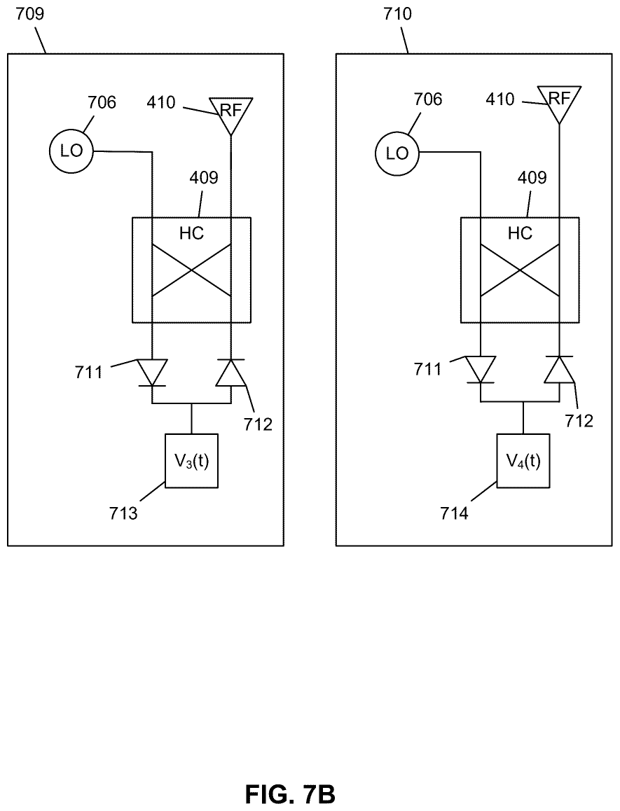

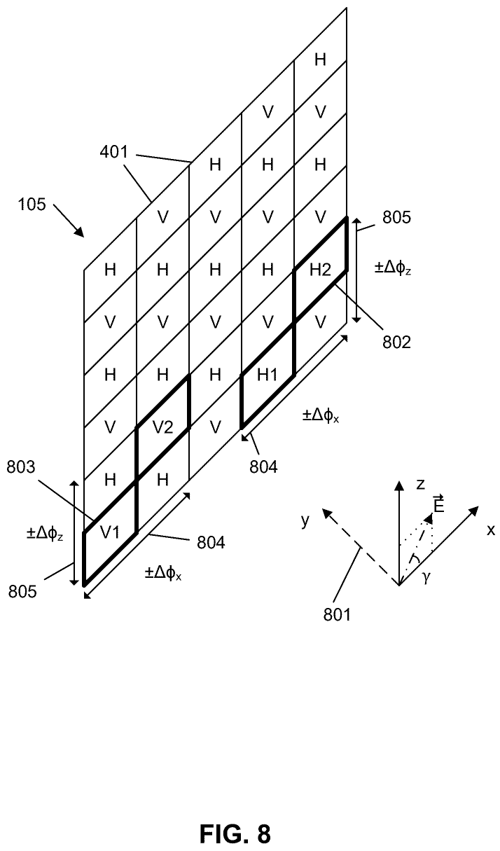

FIG. 7A shows a schematic of a first cell element 701 and a second cell element 702, among a set of four cell elements, configured for receiving communication wireless signals 600, in accordance with an implementation of the present disclosure. The communication wireless signals 600 may, for example, be QAM signals including a quadrature component and an in-phase component. Each of the first cell element 701 and the second cell element 702 may be configured similarly to that described in relation to FIG. 4C. In FIG. 7A, each of the first cell element 701 and the second cell element 702 is shown including: a respective antenna 410, which may be configured to receive RF or mmW wireless signals; a respective low-noise amplifier (LNA) 603; a respective power combiner (PC) 703; a respective power detector 704, which may be configured similarly to the power detector 411 described previously; and a respective phase shifter 705, which may be configured similarly to the FET oscillator 408 described previously. Each of the first cell element 701 and the second cell element 702 may belong to a reconfigurable TM 105 and the respective phase shifter 705 may be phase-locked to a same reference LO signal 706 produced by a reference LO 402. In FIG. 7A, communication wireless signals 600 are received with an AoA with respect to the reconfigurable TM 105. Each phase shifter 705 may be configured to produce a respective input LO signal S_{LO}(t) for the respective cell element. The respective power detector 704 of the first cell element 701 may detect a first output signal ψ₁ depending from the respective power combiner 703 and may accordingly generate a first voltage 707 V₁. The respective power detector 704 of the second cell element 702 may detect a second output signal ψ₂ depending from the respective power combiner 703 and may accordingly generate a second voltage 708 V₂.

For the first cell element 701 and the second cell element 702, the corresponding output signals of the respective power combiners 703 may depend from a combination of the LO signal from the respective phase shifters 705 with the communication wireless signal 600 received by the respective antenna 410, and may be represented as:

$${ψ}_{1} ( t ) = {a}_{LO} {e}^{j ω t} [ 1 + \frac{{a}_{RF}}{{a}_{LO}} α ( t ) {e}^{j ( θ ( t ) - Δ {ϕ}_{RF} )} ] \qquad ( 25 )$$

$${ψ}_{2} ( t ) = {a}_{LO} {e}^{j ω t} [ 1 + \frac{{a}_{RF}}{{a}_{LO}} α ( t ) {e}^{j ( θ ( t ) + Δ {ϕ}_{RF} )} ] \qquad ( 26 )$$

The corresponding voltages generated by the respective power detector 704 may be represented as:

$${V}_{1} ( t ) = {Ka}_{LO}^{2} [ 1 + {( \frac{{a}_{RF}}{{a}_{LO}} )}^{2} {α}^{2} ( t ) + 2 ( \frac{{a}_{RF}}{{a}_{LO}} ) α ( t ) cos ( θ ( t ) - Δ {ϕ}_{RF} ) ] \qquad ( 27 )$$

$${V}_{2} ( t ) = {Ka}_{LO}^{2} [ 1 + {( \frac{{a}_{RF}}{{a}_{LO}} )}^{2} {α}^{2} ( t ) + 2 ( \frac{{a}_{RF}}{{a}_{LO}} ) α ( t ) cos ( θ ( t ) + Δ {ϕ}_{RF} ) ] \qquad ( 28 )$$

A differential voltage V_{D} between the first voltage and the second voltage may provide a quadrature component Q(t) of the received communication wireless signal 600 and may be represented as:

V_{D}(t)=Q(t)=4Ka_{LO}a_{RF}α(t)sin(θ(t))sin(Δφ_{RF}) (29)

In this case, the first cell element 701 and the second cell element 702 may be chosen such that sin (Δφ_{RF}) does not equal zero.

FIG. 7B shows a schematic of a third cell element 709 and a fourth cell element 710, among the set of four cell elements described in relation to FIG. 7A, configured for receiving communication wireless signals 600, in accordance with an implementation of the present disclosure. The communication wireless signals 600 may, for example, be QAM signals including a quadrature component and an in-phase component. Each of the third cell element 709 and the fourth cell element 710 may be configured similarly to that described in relation to FIG. 4C. In FIG. 7B, each of the third cell element 709 and the fourth cell element 710 is shown including: a respective antenna 410, which may be configured to receive RF or mmW wireless signals; a respective hybrid coupler 409; a respective first power detector 711 and a respective second power detector 712, each of which may be configured similarly to the power detector 411 described previously. Each of the third cell element 709 and the fourth cell element 710 may belong to a reconfigurable TM 105. Each hybrid coupler 409 may receive a same reference LO signal 706 produced by a reference LO 402 as an input LO signal S_{LO}(t). In FIG. 7B, communication wireless signals 600 are received with an AoA with respect to the reconfigurable TM 105. The respective first power detector 711 of the third cell element 709 may detect a third output signal ψ₃ depending from one output port of the respective hybrid coupler 409 and may accordingly generate a third voltage 713 ψ₃. The respective first power detector 711 of the fourth cell element 710 may detect a fourth output signal ψ₄ depending from one output port of the respective hybrid coupler 409 and may accordingly generate a fourth voltage 714 V₄.

For the third cell element 709 and the fourth cell element 710, the corresponding output signals of the respective hybrid coupler 409 may be represented as:

$${ψ}_{3} ( t ) = {a}_{LO} {e}^{j ω t} [ 1 + \frac{{a}_{RF}}{{a}_{LO}} α ( t ) {e}^{j ( Δ θ ( t ) - Δ {ϕ}_{RF} - \frac{π}{2} )} ] \qquad ( 30 )$$

$${ψ}_{4} ( t ) = {a}_{LO} {e}^{j ω t} [ 1 + \frac{{a}_{RF}}{{a}_{LO}} α ( t ) {e}^{j ( Δ θ ( t ) + Δ {ϕ}_{RF} - \frac{π}{2} )} ] \qquad ( 31 )$$

The corresponding voltages generated by the respective power detector 704 may be represented as:

$${V}_{3} ( t ) = {Ka}_{LO}^{2} [ 1 + {( \frac{{a}_{RF}}{{a}_{LO}} )}^{2} {α}^{2} ( t ) + 2 ( \frac{{a}_{RF}}{{a}_{LO}} ) α ( t ) sin ( Δθ ( t ) - Δ {ϕ}_{RF} ) ] \qquad ( 32 )$$

$${V}_{4} ( t ) = {Ka}_{LO}^{2} [ 1 + {( \frac{{a}_{RF}}{{a}_{LO}} )}^{2} {α}^{2} ( t ) + 2 ( \frac{{a}_{RF}}{{a}_{LO}} ) α ( t ) sin ( Δθ ( t ) + Δ {ϕ}_{RF} ) ] \qquad ( 33 )$$

A differential voltage V_{D}′ between the third voltage and the fourth voltage may provide an in-phase component I(t) of the received communication wireless signal 600 and may be represented as:

V_{D}′(t)=Q(t)=4Ka_{LO}a_{RF}α(t)cos(θ(t))sin(Δφ_{RF}) (34)

In this case, the third cell element 709 and the fourth cell element 710 may be chosen such that sin (Δφ_{RF}) does not equal zero.

Therefore, by using a set of four cell elements, namely the first cell element 701 and the second cell element 702 described in relation to FIG. 7A and the third cell element 709 and the fourth cell element 710 described in relation to FIG. 7B, both the in-phase and quadrature components of a received communication wireless signal 600 may be detected.

In some implementations of the present disclosure, detection of a polarization of wireless signals may be used in detecting the AoA of wireless signals, which may clarify the azimuth and elevation of a target entity. In these implementations, the plurality of cell elements 401 of a reconfigurable TM 105 may be arranged such that each cell element 401 has a respective polarization orthogonal to that of each other adjacent cell element 401. The respective polarization of each cell element 401 may be determined by the orientation of the respective antenna 411. The aforementioned arrangement may be achieved by alternating, such as over two dimensions, cell elements 401 having a first polarization associated thereto (i.e., ‘first polarization cell elements’) with cell elements 401 having a second polarization associated thereto (i.e., ‘second polarization cell elements’), where the first polarization is orthogonal to the second polarization. Herein, the first polarization may be referred to as horizontal polarization (indicated by ‘H’) and the second polarization may be referred to as vertical polarization (indicated by ‘V’). A person of skill in the art will appreciate that other polarization states may be substituted for the first polarization and the second polarization.

FIG. 8 shows a schematic of a reconfigurable TM 105 including a 2D array of cell elements 401 arranged such that first polarization cell elements (H) alternate with second polarization cell elements (V), in accordance with an implementation of the present disclosure. A wireless signal 801 (indicated by dashed line) having associated thereto an electric field vector E (indicated by dash-dot line) is incident upon the reconfigurable TM 105. The two dimensions of the reconfigurable TM 105 define a cartesian x-axis and z-axis. The electric field vector of the wireless signal, with the x-axis, defines a polarization state for the wireless signal, which is represented by the polarization angle γ. Thus, the electric field vector has a first component proportional to cos(γ) in the direction of the x-axis and a second component proportional to sin(λ) in the direction of the z-axis. In implementations, detection of the first component and the second component may be achieved using a pair of first polarization cell elements 802 (H1 and H2, indicated by bold lines) and a pair of second polarization cell elements 803 (V1 and V2, indicated by bold lines). Output voltages, such as those measured according to the methods described in relation to FIGS. 7A and 7B, for the pair of first polarization cell elements 802 and the pair of second polarization cell elements 803 may be represented as:

V_{H1}(t)=4Ka_{LO}a_{RF}α(t)cos(γ)cos(Δθ(t)−Δφₓ−Δφ_{z}) (35)

V_{H2}(t)=4Ka_{LO}a_{RF}α(t)cos(γ)cos(Δθ(t)+Δφₓ+Δφ_{z}) (36)

V_{V1}(t)=4Ka_{LO}a_{RF}α(t)sin(γ)cos(Δθ(t)−Δφₓ−Δφ_{z}) (37)

V_{V2}(t)=4Ka_{LO}a_{RF}α(t)sin(γ)cos(Δθ(t)+Δφₓ+Δφ_{z}) (38)

where Δφₓ and Δφ_{z} are the phase differences, as determined by Equation 17, between cell elements 401 in the direction of the x-axis 804 and in the direction of the z-axis 805, respectively. The differences in voltage in the pair of first polarization cell elements 802 and in the pair of second polarization cell elements 803 may be used to determine the polarization angle of the wireless signal 801 according to the following:

$$\frac{{V}_{V 1} ( t ) - {V}_{V 2} ( t )}{{V}_{H 1} ( t ) - {V}_{H 2} ( t )} = tan ( γ ) \qquad ( 39 )$$

In implementations, the dimensions of the respective antenna 411 of each cell element 401, as described in relation to FIG. 4C, and the scaling factors associated thereto, as defined by Equations 2 and 3, may be adjusted to optimize polarization detection, as described in relation to FIG. 8.

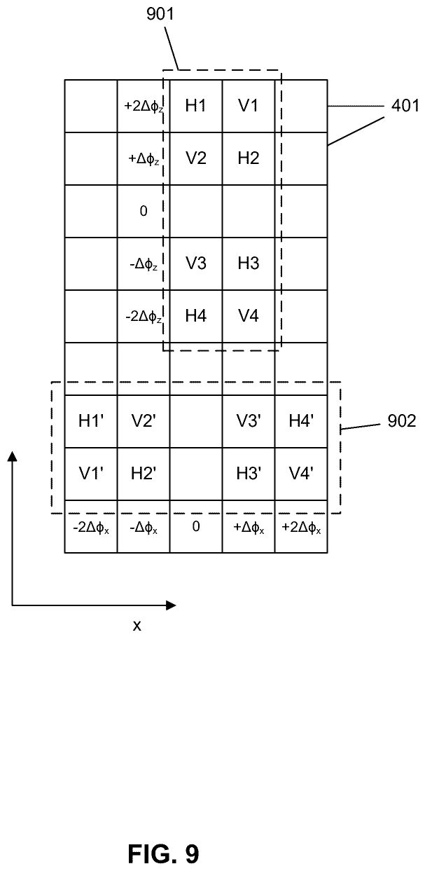

In some implementations of the present disclosure, the AoA of sensing wireless signals may be detected by activating an arrangement of first polarization cell elements and second polarization cell elements. The AoA of the sensing wireless signals may correspond to an azimuth and elevation of a target entity. FIG. 9 shows a schematic of an arrangement of a plurality of cell elements 401 of a reconfigurable TM 105 for detecting AoA, in accordance with an implementation of the present disclosure. Each cell element may include a respective antenna 410, respective hybrid coupler 409, a respective first power detector 504, and a respective second power detector 505, as described previously. The plurality of cell elements 401 may be arranged as a 2D array, in a grid-like fashion, wherein first polarization cell elements alternate with second polarization cell elements over the two dimensions, which may correspond to a cartesian x-axis and z-axis. At least some of the plurality of cell elements 401 may belong to a first set 107 of cell elements configured for sensing. The first set 107 of cell elements may include a first subset 901 of cell elements and a second subset 902 of cell elements. The first subset 901 of cell elements may detect a component of the AoA of the sensing wireless signals in the direction of the z-axis, which may correspond to the elevation of a target entity. The second subset 902 of cell elements may detect a further component of the AoA of the sensing wireless signals in the direction of the x-axis, which may correspond to the azimuth of the target entity. Each of the first subset 901 of cell elements and the second subset 902 of cell elements may include a respective plurality of pairs of cell elements. Each pair of cell elements may include a respective first polarization cell element and a respective second polarization cell element. The respective plurality of pairs of cell elements of the first subset 901 may be arranged sequentially in the direction of the z-axis. The respective plurality of pairs of cell elements of the second subset 902 may be arranged sequentially in the direction of the x-axis. A respective one or more cell elements from among the plurality of cell elements 401 of the reconfigurable TM 105, such as those not belonging to the first set 107 of cell elements, may interrupt the sequential arrangement of the respective plurality of pairs of cell elements of each of the first subset 901 of cell elements and the second subset 902 of cell elements. For example, as shown in FIG. 9, each of the first subset 901 of cell elements and the second subset 902 of cell elements may include a respective four pairs of cell elements (e.g., H1 & V1, H2 & V2, H3 & V3, and H4 & V4 for the first subset 901), which may be arranged such that a respective first half of the respective four pairs (e.g., H1 & V1 and H2 and V2 for the first subset 901) are separated from a respective second half of the respective four pairs (e.g., H3 & V3 and H4 & V4 for the first subset 901) by a pair of other cell elements 401 of the reconfigurable TM 105. The respective pairs of cell elements of the first subset 901 of cell elements may receive wireless signals with a respective phase difference, as defined by Equation 17, in the direction of the z-axis of iΔφ_{z} relative to the interrupting other cell elements 401, where i=−2, −1, +1, +2 (as indicated alongside the first subset 901 of cell elements in FIG. 9). The respective pairs of cell elements of the second subset 902 of cell elements may receive wireless signals with a respective phase difference, as defined by Equation 17, in the direction of the x-axis of iΔφₓ relative to the interrupting other cell elements 401, where i=−2, −1, +1, +2 (as indicated alongside the second subset 901 of cell elements in FIG. 9) and indicates the position of each pair of cell elements.

For the first subset 901 of cell elements, the respective sensing wireless signal received by the i^{th} pair of cell elements may be represented as:

S_{RF,i}(t)=a_{RF}α(t)e^{j(ωt+θ(t)+iΔφ}^{_{z}}⁾ (40)

For each cell element of the i^{th} pair of cell elements, respective output signals of the respective hybrid coupler 409 may be represented as:

$${ψ}_{1 , i} ( t ) = \frac{- {a}_{LO}}{\sqrt{2}} {e}^{j ω t} [ j \frac{{a}_{RF}}{{a}_{LO}} α ( t ) {e}^{j ( Δθ ( t ) + Δ {ϕ}_{Z} )} + 1 ] \qquad ( 41 )$$

$${ψ}_{2 , i} ( t ) = \frac{- {a}_{LO}}{\sqrt{2}} {e}^{j ω t} [ \frac{{a}_{RF}}{{a}_{LO}} α ( t ) {e}^{j ( Δ θ ( t ) + Δ {ϕ}_{Z} )} + j ] \qquad ( 42 )$$

The corresponding voltages generated by the respective first power detector 504 and the respective second power detector 505 may be proportional to the received power and represented as:

$${V}_{1 , i} ( t ) = K \frac{{a}_{LO}^{2}}{2} [ 1 + {( \frac{{a}_{RF}}{{a}_{LO}} )}^{2} {α}^{2} ( t ) + 2 ( \frac{{a}_{RF}}{{a}_{LO}} ) α ( t ) sin ( θ ( t ) + i {Δϕ}_{z} ) ] \qquad ( 43 )$$

$${V}_{2 , i} ( t ) = K \frac{{a}_{LO}^{2}}{2} [ 1 + {( \frac{{a}_{RF}}{{a}_{LO}} )}^{2} {α}^{2} ( t ) - 2 ( \frac{{a}_{RF}}{{a}_{LO}} ) α ( t ) sin ( θ ( t ) + i {Δϕ}_{z} ) ] \qquad ( 44 )$$

For each cell element of the i^{th} pair of cell elements, a respective differential voltage Vp between the above voltages may be represented as:

V_{D,i}(t)=2Ka_{LO}a_{RF}[α(t)sin(θ(t)+iΔφ_{z})] (45)

With the respective differential voltages determined for the respective plurality of pairs of cell elements of the first subset 901 of cell elements, Δφ_{z} may be determined according to:

$$Δ {ϕ}_{z} = {cos}^{- 1} ( \frac{{\overline{V}}_{D , 4} - {\overline{V}}_{D , 1}}{2 ( {\overline{V}}_{D , 3} - {\overline{V}}_{D , 2} )} ) \qquad ( 46 )$$

where V̅_{D,i} is the mean of the respective differential voltages of each cell element of the i^{th} pair of cell elements. In accordance with Equation 17, the component of the AoA in the direction of the z-axis AoA_{z} may be determined by:

$${AoA}_{z} = {cos}^{- 1} ( \frac{λ}{2 π d} {cos}^{- 1} ( \frac{{\overline{V}}_{D , 4} - {\overline{V}}_{D , 1}}{2 ( {\overline{V}}_{D , 3} - {\overline{V}}_{D , 2} )} ) ) \qquad ( 47 )$$

which may further be used to detect the elevation of the target entity.

A similar analysis may be performed for the second subset 902 of cell elements such that the further component of the AoA in the direction of the x-axis may be determined according to:

$${AoA}_{x} = {cos}^{- 1} ( \frac{λ}{2 π d} {cos}^{- 1} ( \frac{{\overline{V}}_{D , {4}^{′}} - {\overline{V}}_{D , {1}^{′}}}{2 ( {\overline{V}}_{D , {3}^{′}} - {\overline{V}}_{D , {2}^{′}} )} ) ) \qquad ( 48 )$$

which may further be used to detect the azimuth of the target entity.

In some implementations of the present disclosure, a calibration factor may be applied when receiving communication wireless signals 600 to address polarization mismatch, which may occur when the polarization state of the incident communication wireless signals 600 is not aligned respective polarization of each cell element 401 and may result in sub-optimal power absorption. For a pair of first polarization cell elements 802 (H1 and H2) and a pair of second polarization cell elements 803 (V1 and V2) belonging to a reconfigurable TM 105, as described in relation to FIG. 8, the received communication wireless signals 600 may be represented as:

S_{RF,H1}(t)=a_{RF}α(t)e^{j(ωt+θ(t)-Δφ}^{ₓ}^{+Δφ}^{_{z}}⁾cos(γ) (49)

S_{RF,V1}(t)=a_{RF}α(t)e^{j(ωt+θ(t)+Δφ}^{ₓ}^{+Δφ}^{_{z}}⁾sin(γ) (50)

S_{RF,H2}(t)=a_{RF}α(t)e^{j(ωt+θ(t)+Δφ}^{ₓ}^{-Δφ}^{_{z}}⁾cos(γ) (51)

S_{RF,V2}(t)=a_{RF}α(t)e^{j(ωt+θ(t)-Δφ}^{ₓ}^{-Δφ}^{_{z}}⁾sin(γ) (52)

Output voltages, such as those measured by a respective power detector 411, for the pair of first polarization cell elements 802 and the pair of second polarization cell elements 803 may be represented as V_{H1}(t), V_{H2}(t), V_{V1}(t), and V_{V2}(t). A first calibration factor ξ₁ and a second calibration factor ξ₂ may be used towards demodulation of the quadrature components of the received communication wireless signals 600 according to:

$$Q ( t ) = {ξ}_{1} ( {V}_{H 1} ( t ) - {V}_{H 2} ( t ) ) + ( {V}_{V 2} ( t ) - {V}_{V 1} ( t ) ) \qquad ( 57 )$$

$$where$$

$${ξ}_{1} = \frac{1}{cos ( γ )} \qquad ( 58 )$$

$$and$$

$${ξ}_{2} = \frac{1}{sin ( γ )} \qquad ( 59 )$$

To demodulate the in-phase components of the received communication wireless signals 600, a further pair of first polarization cell elements (H1′ and H2′) and a further pair of second polarization cell elements (V1′ and V2′) belonging to the reconfigurable TM 105 and configured similarly to the pair of first polarization cell elements 802 and the pair of second polarization cell elements 803 may be used. Each of the further pair of first polarization cell elements and the further pair of second polarization cell elements may be phase locked with a 90 degree shift respect to the pair of first polarization cell elements 802 and the pair of second polarization cell elements 803. The in-phase components may then be demodulated according to:

I(t)=ξ₁(V_{H1′}(t)−V_{H2′}/(t))+(V_{V2′}(t)−V_{V1′}(t)) (60)

In implementations of the present disclosure, the range and speed of a target entity may be detected by a reconfigurable TM 105. To determine range and speed, frequency shifts in the received sensing wireless signals that are caused by the Doppler effect may be analyzed. To enhance the detection of range and speed, phase differences among a plurality of cell elements 401, clutter suppression, and/or adaptive filtering may be incorporated. The range and speed may be determined using the beat up-beat frequency fᵤ, down-beat frequency f_{d}, initial frequency f₀, and frequency shift Δf, as described in relation to FIG. 1B, according to:

$${f}_{R} = \frac{1}{2} [ {f}_{u} + {f}_{d} ] \qquad ( 61 )$$

$${f}_{D} = \frac{1}{2} [ {f}_{u} - {f}_{d} ] \qquad ( 62 )$$

$$Range = \frac{{cf}_{R}}{4 {f}_{m} Δ f} \qquad ( 63 )$$

$$Speed = \frac{{cf}_{D}}{2 {f}_{0}} \qquad ( 64 )$$

where fₘ is the modulating frequency.

Implementations of the present disclosure may be implemented using electronics hardware, software, or a combination thereof. In some implementations, the invention may be implemented by one or multiple computer processors executing program instructions stored in memory. In some implementations, the invention may be implemented partially or fully in hardware, for example using one or more field programmable gate arrays (FPGAs) or application specific integrated circuits (ASICs) to rapidly perform processing operations.

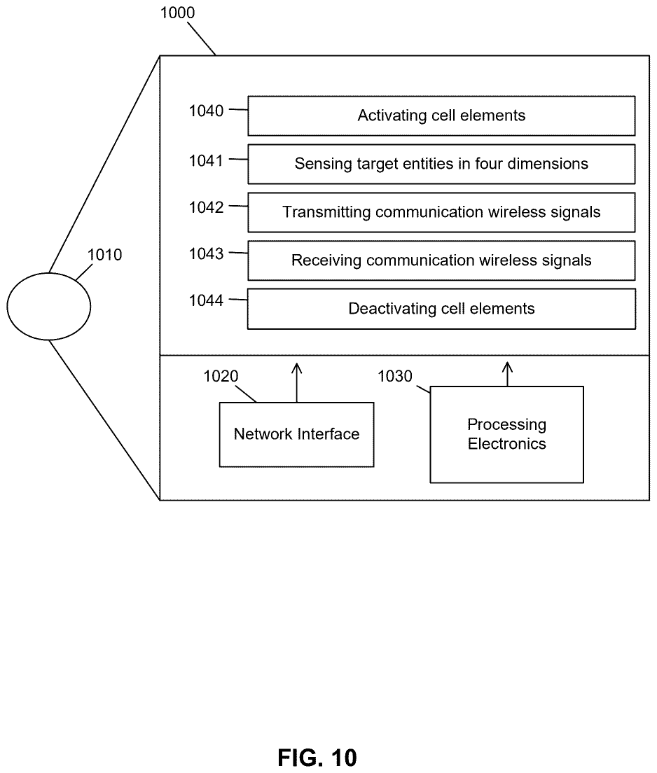

FIG. 10 shows an apparatus 1000 for sensing and communicating by wireless signals, according to implementations of the present disclosure. The apparatus 1000 may be located at a node 1010 of a network. The apparatus 1000 may further be located on a vehicle, such as for ADAS and autonomous driving. The apparatus 1000 may include a network interface 1020 and processing electronics 1030. The processing electronics 1030 may include a computer processor executing program instructions stored in memory, or other electronics components such as digital circuitry, including for example FPGAs and ASICs. The network interface 1020 may include an optical communication interface or radio communication interface, such as a transmitter and receiver. The apparatus 1000 may include several functional components, each of which may be partially or fully implemented using the underlying network interface 1020 and processing electronics 1030. Examples of functional components may include modules for activating 1040 cell elements of a reconfigurable TM, sensing 1041 target entities in four dimensions, transmitting 1042 communication wireless signals, receiving 1043 communication wireless signals, and deactivating 1044 cell elements of the reconfigurable TM.

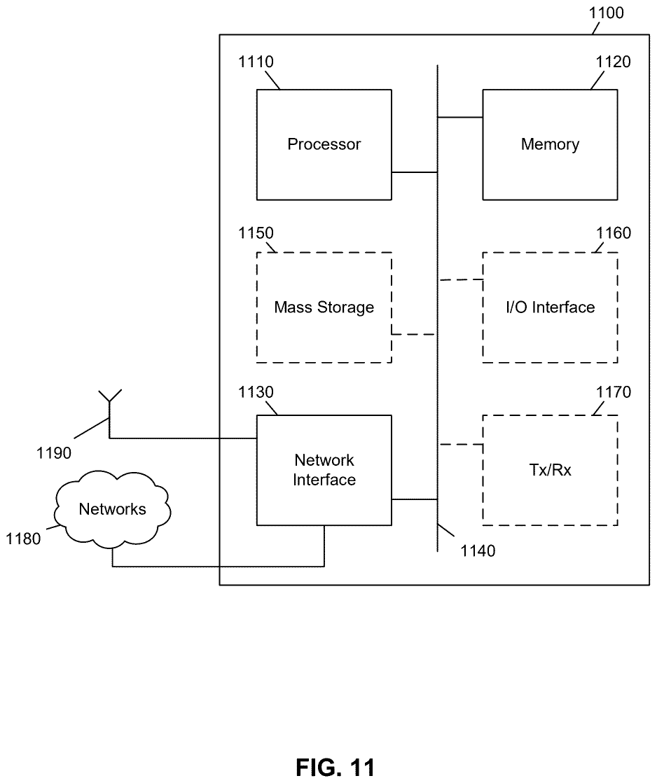

FIG. 11 shows a schematic diagram of an electronic device 1100 that may perform any or all of the operations of the above methods and features explicitly or implicitly described herein, according to different implementations of the present disclosure. For example, a computer equipped with network function may be configured as electronic device 1100. The electronic device 1100 may be used to implement the apparatus 1000 of FIG. 10, for example. The electronic device 1100 may further be used as part of or coupled to a reconfigurable TM 105, for example. In particular, the electronic device 1100 may be configured, for example, to control the reconfigurable TM 105 by activating or deactivating cell elements 401, supply input signals to cell elements 401 for transmission, and process voltages representing wireless signals received by cell elements 401.

As shown, the electronic device 1100 may include a processor 1110, such as a Central Processing Unit (CPU) or specialized processors such as a Graphics Processing Unit (GPU) or other such processor unit, memory 1120, network interface 1130, and a bi-directional bus 1140 to communicatively couple the components of electronic device 1100. Electronic device 1100 may also optionally include non-transitory mass storage 1150, an I/O interface 1160, and a transceiver 1170. According to certain implementations, any or all of the depicted elements may be utilized, or only a subset of the elements. Further, the electronic device 1100 may contain multiple instances of certain elements, such as multiple processors, memories, or transceivers. Also, elements of the hardware device may be directly coupled to other elements without the bi-directional bus 1140. Additionally or alternatively to a processor and memory, other electronics, such as integrated circuits, may be employed for performing the required logical operations.

The memory 1120 may include any type of tangible, non-transitory memory such as static random access memory (SRAM), dynamic random access memory (DRAM), synchronous DRAM (SDRAM), read-only memory (ROM), any combination of such, or the like. The mass storage element 1150 may include any type of tangible, non-transitory storage device, such as a solid state drive, hard disk drive, a magnetic disk drive, an optical disk drive, USB drive, or any computer program product configured to store data and machine executable program code. According to certain implementations, the memory 1120 or mass storage 1150 may have recorded thereon statements and instructions executable by the processor 1110 for performing any of the aforementioned method operations described above.

Network interface 1130 may include at least one of a wired network interface and a wireless network interface. The network interface 1130 may include a wired network interface to connect to a communication network 1180 and may also include a radio access network interface 1190 for connecting to the communication network 1180 or other network elements over a radio link. The network interface 1130 enables the electronic device 1100 to communicate with remote entities such as those connected to the communication network 1180.

It will be appreciated that, although specific implementations of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding implementations, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product may include a number of instructions that enable a computer device (personal computer, server, or network device) to execute the methods provided in the implementations of the present disclosure. For example, such an execution may correspond to a simulation of the logical operations as described herein. The software product may additionally or alternatively include number of instructions that enable a computer device to execute operations for configuring or programming a digital logic apparatus in accordance with implementations of the present disclosure.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise. The phrase “at least one” means one or more, and “a plurality of” means two or more. In addition, “and/or” describes an association relationship of associated objects, and indicates that there may be three relationships. For example, A and/or B may indicate cases including “only A”, “both A and B”, and “only B”, where A and B may be singular or plural. The character “/” generally indicates that the associated objects are in an OR relationship. “At least one of the following items” or a similar expression thereof refers to any combination of these items, including any combination of a single item or a plurality of items. For example, “at least one of a, b, or c” may represent “a”, “b”, “c”, “a and b”, “a and c”, “b and c”, or “a, b and c”, where a, b, and c may be a single or multiple form.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated implementations, not all of them need to be combined to realize the benefits of various implementations of this disclosure. In other words, a system or method designed according to an implementation of this disclosure will not necessarily include all features shown in any one of the Figures or all portions schematically shown in the Figures. Moreover, selected features of one example implementation may be combined with selected features of other example implementations.

Although the present invention has been described with reference to specific features and implementations thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method comprising:
detecting, by a first set of cell elements among a plurality of cell elements of a reconfigurable transceiver matrix (TM), a target entity and, for the target entity, an elevation and an azimuth relative to the reconfigurable TM, each cell element of the plurality of cell elements including a respective antenna coupled to a respective local oscillator (LO) phase locked to a same reference signal, each antenna configured to transmit and receive wireless signals;
receiving, by a second set of cell elements among the plurality of cell elements of the reconfigurable TM, a first set of communication wireless signals from the target entity, the first set of communication wireless signals defining a first data message;
and
transmitting, by a third set of cell elements among the plurality of cell elements of the reconfigurable TM, a second set of communication wireless signals to the target entity in accordance with the elevation and the azimuth detected for the target entity, the second set of communication wireless signals defining a second data message, at least one cell element of the third set of cell elements being phase locked to the same reference signal with a 90 degree shift relative to at least one other cell element of the third set of cell elements.

2. The method of claim 1 further comprising:
adding at least one cell element among the plurality of cell elements of the reconfigurable TM to the second set of cell elements to improve a value of a reception metric.

3. The method of claim 2 wherein the receiver metric is a signal-to-noise ratio.

4. The method of claim 2 wherein:
each cell element among the plurality of cell elements of the reconfigurable TM is either in an active state or an inactive state;
each cell element of the second set of cell elements is in the active state;
and
the at least one cell element is added to the second set of cell elements by switching the at least one cell element from the inactive state to the active state.

5. The method of claim 1 further comprising:
adding at least one cell element among the plurality of cell elements of the reconfigurable TM to the third set of cell elements to improve a value of a transmission metric.

6. The method of claim 5 wherein the transmission metric is a signal gain.

7. The method of claim 5 wherein:
each cell element among the plurality of cell elements of the reconfigurable TM is either in an active state or an inactive state;
each cell element of the third set of cell elements is in the active state;
and
the at least one cell element is added to the third set of cell elements by switching the at least one cell element from the inactive state to the active state.

8. The method of claim 1 further comprising:
removing at least one cell element from the first set of cell elements, the second set of cell elements, or the third set of cell elements to improve a value of a power usage metric.

9. The method of claim 8 wherein:
each cell element among the plurality of cell elements of the reconfigurable TM is either in an active state or an inactive state;
and
the at least one cell element is removed from the first set of cell elements, the second set of cell elements, or the third set of cell elements by switching the at least one cell element from the active state to the inactive state.

10. The method of claim 1 wherein the second set of communication wireless signals is transmitted to the target entity by the third set of cell elements of the reconfigurable TM when the first set of communication wireless signals is received from the target entity by the second set of cell elements of the reconfigurable TM.

11. The method of claim 1 wherein:
each communication wireless signal of the second set of communication wireless signals is a quadrature-amplitude modulation signal including a respective in-phase component and a respective quadrature component;
each in-phase component is transmitted by the at least one cell element of the third set of cell elements;
and
each quadrature component is transmitted by the at least one other cell element of the third set of cell elements.

12. The method of claim 1 wherein:
each communication wireless signal of the first set of communication wireless signals is a quadrature-amplitude modulation signal including a respective in-phase component and a respective quadrature component;
at least one cell element of the second set of cell elements is phase locked to the same reference signal with a 90 degree shift relative to at least one other cell element of the second set of cell elements;
and
the method further comprises:
detecting, when the first set of communication wireless signals is received by the second set of cell elements:
each in-phase component of the first set of communication wireless signals by the at least one cell element of the second set of cell elements,
and
each quadrature component of the first set of communication wireless signals by the at least one other cell element of the second set of cell elements.

13. The method of claim 1 wherein:
each communication wireless signal of the first set of communication wireless signals is a quadrature-amplitude modulation signal including a respective in-phase component and a respective quadrature component;
each cell element of a first subset of cell elements among the second set of cell elements includes a respective power combiner;
each cell element of a second subset of cell elements among the second set of cell elements includes a respective hybrid coupler;
and
the method further comprises:
detecting, when the first set of communication wireless signals is received by the second set of cell elements:
each quadrature component of the first set of communication wireless signals by the first subset of cell elements among the second set of cell elements,
and
each in-phase component of the first set of communication wireless signals by the second subset of cell elements among the second set of cell elements.

14. The method of claim 1 further comprising:
detecting, by the first set of cell elements of the reconfigurable TM, a distance and a speed for the target entity and relative to the reconfigurable TM.

15. The method of claim 1 wherein detecting, by the first set of cell elements of the reconfigurable TM, the target entity and, for the target entity, the elevation and the azimuth relative to the reconfigurable TM includes:
transmitting, by the first set of cell elements of the reconfigurable TM, a set of sensing wireless signals;
and
receiving, by the first set of cell elements of the reconfigurable TM, at least a subset of the set of sensing wireless signals reflected by the target entity.

16. The method of claim 15 wherein:
the set of sensing wireless signals has associated thereto a frequency modulation; and
detecting, by the first set of cell elements of the reconfigurable TM, the target entity and, for the target entity, the elevation and the azimuth relative to the reconfigurable TM further includes:
identifying, by the first set of cell elements of the reconfigurable TM, a plurality of beat frequencies in the subset of the set of sensing wireless signals depending from the frequency modulation.

17. The method of claim 1 wherein:
each cell element of the plurality of cell elements of the reconfigurable TM is a first polarization cell element or a second polarization cell element, the respective antenna of each first polarization cell element having associated thereto a first polarization, the respective antenna of each second polarization cell element having associated thereto a second polarization orthogonal to the first polarization;
the plurality of cell elements of the reconfigurable TM are arranged to alternate between the first polarization and the second polarization in two dimensions;
the first set of cell elements of the reconfigurable TM includes a first subset of cell elements and a second subset of cell elements, each of the first subset of cell elements and the second subset of cell elements including a respective plurality of pairs of cell elements, each pair of cell elements including a respective first polarization cell element and a respective second polarization cell element;
the elevation of the target entity is detected by the first subset of cell elements of the first set of cell elements;
and
the azimuth of the target entity is detected by the second subset of cell elements of the first set of cell elements.

18. The method of claim 17 wherein:
the respective plurality of pairs of cell elements of the first subset of cell elements of the first set of cell elements includes a respective four pairs of cell elements arranged sequentially in one dimension of the two dimensions;
and
the respective plurality of pairs of cell elements of the second subset of cell elements of the first set of cell elements includes a respective four pairs of cell elements arranged sequentially in an other dimension of the two dimensions.

19. The method of claim 18 wherein:
the respective four pairs of cell elements of the first subset of cell elements of the first set of cell elements are partitioned into a respective first half of pairs of cell elements separated, along the one dimension of the two dimensions, from a respective second half of pairs of cell elements by at least one cell element from among the plurality of cell elements of the reconfigurable TM;
and
the respective four pairs of cell elements of the second subset of cell elements of the first set of cell elements are partitioned into a respective first half of pairs of cell elements separated, along the other dimension of the two dimensions, from a respective second half of pairs of cell elements by a further at least one cell element from among the plurality of cell elements of the reconfigurable TM.

20. An apparatus comprising a reconfigurable transceiver matrix (TM) including a plurality of cell elements each including a respective antenna coupled to a respective local oscillator (LO) phase locked to a same reference signal, each cell element configured to:
detect, by a first set of cell elements among the plurality of cell elements of the reconfigurable TM, a target entity and, for the target entity, an elevation and an azimuth relative to the reconfigurable TM;
receive, by the respective antenna of each cell element of a second set of cell elements among the plurality of cell elements of the reconfigurable TM, a first set of communication wireless signals from the target entity, the first set of communication wireless signals defining a first data message;
and
transmit, by the respective antenna of each cell element of a third set of cell elements among the plurality of cell elements of the reconfigurable TM, a second set of communication wireless signals to the target entity in accordance with the elevation and the azimuth detected for the target entity, the second set of communication wireless signals defining a second data message, at least one cell element of the third set of cell elements being phase locked to the same reference signal with a 90 degree shift relative to at least one other cell element of the third set of cell elements.
